(19) United States
(12) Patent Application Publication
(10) Pub. No.: US 2015/0142392 A1
(43) Pub. Date: May 21, 2015

(54) METHOD FOR DESIGNING A LOCAL COIL TO BE USED IN A COMBINED PET MAGNETIC RESONANCE DEVICE FOR MAGNETIC RESONANCE IMAGING AND LOCAL COIL

(71) Applicant: Siemens Aktiengesellschaft, Munich (DE)

(72) Inventors: Ralf LADEBECK, Erlangen (DE); Daniel PAULUS, Nuernberg (DE); Harald H. QUICK, Erlangen (DE); Jürgen STEPHAN, Puchheim (DE)

(21) Appl. No.: 14/532,103

(22) Filed: Nov. 4, 2014

(30) Foreign Application Priority Data
Nov. 18, 2013 (DE) 102013223482.1

(51) Int. Cl. G06F 17/50

(52) U.S. Cl. CPC G06F 17/50
USPC 703/1

(57) ABSTRACT

A method is disclosed for designing a local coil to be used in a combined PET magnetic resonance device for magnetic resonance imaging in relation to the arrangement of radiation-attenuating electronic elements in an irradiation area for PET photons. In an embodiment of the method, taking into consideration at least one boundary condition specifying the degree of freedom of the positioning of the electronic elements, optimization of the positions of the electronic elements is undertaken in an optimization method in respect of a uniform distribution of attenuation centers which is as substantial as possible.

### PRIORITY STATEMENT

The present application hereby claims priority under 35 U.S.C. §119 to German patent application number DE 102013223482.1 filed Nov. 18, 2013, the entire contents of which are hereby incorporated herein by reference.

### FIELD

At least one embodiment of the invention generally relates to a method for designing a local coil to be used in a combined PET magnetic resonance device for magnetic resonance imaging in relation to the arrangement of radiation-attenuating electronic elements in an irradiation area for PET photons, as well as to a local coil.

### BACKGROUND

Imaging devices which allow a plurality of imaging modalities, frequently two, are already widely known. These also include imaging devices which allow both PET imaging (positron emission tomography imaging) and also MR imaging (magnetic resonance imaging). Such imaging devices are frequently referred to as combined PET magnetic resonance imaging devices.

Embodiments are known for example in which a PET detector arrangement is provided surrounding the patient chamber of a main magnet unit as well as a gradient coil arrangement and a high frequency coil arrangement, usually between the gradient coil arrangement and the high frequency coil arrangement. The high-frequency coil arrangement in such cases is designed so that attenuations which are too strong occur for the fewest possible Lines of Response (LOR), i.e. event lines in the imaging area. This is because, with positron emission tomography imaging two photons moving in exactly opposing directions, which ideally can both be measured, occur through annihilation of an electron and a positron.

What are known as local coils are often used for magnetic resonance imaging, which are to be arranged close to the imaging area, especially on a patient, to enable magnetic resonance signals of a better quality to be recorded. In particular the signal-to-noise ratio (SNR) can be improved in this way. Various local coils are known, which can be applied close to the patient's body for different areas of the patient. Examples of the coils are head coils, neck coils, extremity coils and the like. If a combined PET-MR imaging is carried out with a PET magnetic resonance device, the local coils used the magnetic resonance imaging are located at least partly in the irradiation area of the PET annihilation photons and thus lead to a possible attenuation problem when too great a level of attenuation and/or scattering occurs.

DE 10 2008 046 974 A1 discloses measures for optimization of local coils for PET imaging. In this document, to minimize the attenuation of PET radiation in a combined MR-PET device, it is proposed to align the surfaces of a wall of a local coil device remote from the object tangentially to an examination object. Thus the radiation always penetrates the housing wall orthogonally, i.e. on the shortest possible path. It is further proposed to manufacture the wall on the object side and/or the wall remote from the object from a polymer foam.

However these investigations deal solely with the embodiment of the housing of the local coil, which however also has further potentially radiation-attenuating components, especially various electronic elements, which could blot out PET signals. The position of such electronic elements is determined in accordance with the prior art in respect of a symmetrical embodiment and the minimization of electric fields created.

### SUMMARY

At least one embodiment of the invention specifies a design method for the arrangement of electronic elements which is better suited to the specific purpose of use in MR-PET hybrid modalities and thus allows a better image quality, in particular for PET imaging.

A method of an embodiment of the invention takes into account at least one boundary condition specifying the degree of freedom of the positioning of the electronic elements. The positions of the electronic elements are optimized in an optimization method in respect of the most substantial uniform distribution of attenuation centers possible.

In general, it should be noted that a plurality of optimization algorithms is already known which can also be used within the context of embodiments of the present invention in order, for example, to realize a computer program which carries out the optimization method and outputs an optimum arrangement of the electronic elements. Since optimization methods with the variables to be optimized, here the position of the electronic elements, of the target functions (here related to uniform distribution) and boundary conditions are commonly-used material for the person skilled in the art, the methods will not be discussed in greater detail here.

As well as the method, an embodiment of the invention also relates to a local coil with an arrangement of electronic elements determined with an embodiment of the inventive method. A local coil thus created in accordance with an embodiment of the inventive method is thus characterized in that the heavily-attenuating electronic elements are far better distributed in respect of use in PET imaging, especially approximately evenly distributed. By comparison with prior-art local coils, electronic elements are thus displaced, possibly into areas outside the irradiation area.

### BRIEF DESCRIPTION OF THE DRAWINGS

Further advantages and details of the present invention emerge from the example embodiments described below and also with reference to the drawings, in which:

FIG. 1 shows a schematic section through a prior-art combined PET magnetic resonance device,

FIG. 2 shows a flowchart of an embodiment of the inventive method,

FIG. 3 shows a diagram for the distribution of electronic elements in a prior-art local coil,

FIG. 4 shows a diagram of an arrangement of the electronic elements resulting from the inventive method,

FIG. 5 shows a diagram for radiation attenuation for electronic elements arranged symmetrically in the circumferential direction, and

FIG. 6 shows a diagram for radiation attenuation for electronic elements not arranged symmetrically in the circumferential direction.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A method of an embodiment of the invention takes into account at least one boundary condition specifying the degree of freedom of the positioning of the electronic elements. The positions of the electronic elements are optimized in an optimization method in respect of the most substantial uniform distribution of attenuation centers possible.

In this way the heavily-attenuating components, i.e. the electronic elements, are arranged so that the components are as evenly distributed as possible in at least one direction of the local coil, especially generally, so that thus a uniform distribution of attenuation centers exists and no accumulations of electronic elements exist any longer which in specific areas cause too great an attenuation of the PET signal. In such cases, an irradiation area is considered, through which PET photons actually pass when it is in use, thus the optimization is undertaken where it is necessary in respect of imaging.

If for example, for a local coil known from the prior art, a plurality of electronic elements is arranged in a specific subarea of the irradiation area, but only very few or no electronic elements at all are arranged in a further subarea, it can be proposed in the optimization method, where possible, to shift some of the electronic elements from the first subarea into the second subarea. Overall it is thus conceivable in an embodiment to divide up the irradiation area into different subareas, for which an even distribution of the electronic elements can be realized for example such that the same number of electronic elements are located in each subarea or the attenuation produced by the electronic elements is the same in each subarea, if necessary within a tolerance range.

An embodiment of the inventive method further also makes it possible, compared to known local coils, to now arrange electronic elements previously arranged in the irradiation area outside the irradiation area, if the boundary conditions for positioning allows this. An optimization is thus undertaken with which as little highly-attenuating material as possible is located in the field of view (FOV), i.e. the imaging area, of the PET detectors.

In this way, an embodiment of the inventive method makes possible the creation of innovative local coils in which the arrangement of heavily-attenuating electronic elements is optimized for PET radiation, so that both the PET image quality can be improved and also measurements can be taken with less radioactivity, which reduces the radiation load for the patient.

In such cases, different types of electronic element can be taken into account, especially pulse-shortening capacitors and/or at least one component of a detuning circuit, especially a PIN diode, and/or decoupling capacitors and/or preamplifiers and/or solder points, especially manual solder points, as well as other conceivable heavily-attenuating components. As a boundary condition for the positioning of the electronic elements—as well as the natural orientation on the course of the coil conductors—for example with impedance-balanced preamplifiers, the option of providing Lambda/2 lines receiving the impedance balance is used.

Although preamplifiers in currently known local coils are frequently located in any event outside the irradiation area, they thus do not absolutely have to be taken into account in such a case in the optimization method, but cases are also conceivable in which the irradiation area contains preamplifiers. This is especially true if more extensive areas are to be imaged, which will be covered by a number of local coils. In this case it can be expedient to remove preamplifiers further from the coil conductors forming the individual coil elements, wherein frequently the positioning of the preamplifiers is selected so that the smallest possible input impedance is present and thus an impedance balancing is provided. In order to obtain this a displacement of preamplifiers away from the coil elements which are formed by the coil conductors is possible precisely when the condition for impedance balancing is maintained, thus Lambda/2 lines are used, if necessary naturally also lines of a length of a whole-number multiple of Lambda/2.

As a further possible boundary condition for the positioning of electronic elements, there can be provision with pulse-shortening capacitors for a positioning receiving the desired resonance to be used. Pulse-shortening capacitors which set the coil elements which are formed by the coil conductors to the correct resonant frequency can usually not be displaced to any given distance along the coil conductor but limits exist which can be taken into consideration as boundary conditions in the inventive method. For detuning circuits for example, via which the coil elements are switched off during transmission, such a restriction does not exist: they are ultimately able to be displaced freely along the coil conductors forming the coil elements.

In a development of an embodiment of the invention, there can be provision for a function evaluating the course of the attenuation in at least one direction on an envelope surface enclosing the local coil to be used as the target function. In this case a number of directions are preferably considered in the irradiation area on the envelope surface, wherein provision can be made for example that, for an essentially cylindrical local coil, at least one longitudinal direction and at least one circumferential direction will be considered. The aim of the optimization method is then ultimately a curve which is as even as possible which does not exceed specific attenuation values.

In concrete terms there can be provision that, for evaluation of the attenuation curve, at least one band of permissible attenuation values, especially an allowed deviation from an average value, is considered, wherein areas lying outside the band, especially areas lying above the band, make the evaluation worse. In such cases it is especially avoided that in different planes in the radiation direction electronic elements lying above one another occur and the like. In addition subareas can also be considered in the direction for which it is assessed in each case how greatly the integrals in the subareas deviate from one another and the like. In this case it should again be mentioned that the attenuation curve is of course only evaluated within the irradiation area.

As already mentioned, with an essentially cylindrical local coil, for example a head coil or an extremity coil, it is expedient for at least one longitudinal direction and at least one circumferential direction to be considered.

For the circumferential direction ultimately also enclosing the imaging area there can be expediently be provision that, as a boundary condition or a modification of the target function, electronic elements lying opposite one another with a circumferential direction are assessed less well in the optimization method. This means that the aim of the optimization method can be that, in a plane at right angles to the longitudinal direction of the cylinders, no heavily-attenuating electronic elements lie symmetrically opposite one another. If this is namely the case for a greater number of electronic elements, this results in an extremely heavy shadowing in the thoroughly relevant central area, i.e. in the middle of the circumferential direction describing a circle, since in different Lines of Response there in both directions a heavy attenuation occurs, so that possibly far fewer photons arrive from this central area for measurement. A non-symmetrical distribution of the electronic elements along such a circumferential direction in one plane avoids intersection points of connecting lines between electronic elements frequently meeting one another, as occurs in the symmetrical case in the center.

In a further embodiment, this target function can also have a component acting on a minimization of the electric fields occurring. In this case the components, especially i.e. a component for the even distribution and a component for the electric fields, are considered weighted, so that also in relation to the electric field, an optimization can further take place. As an alternative or in addition it is also conceivable for a boundary condition delimiting the electric field occurring through the local coil to be used. Overall this avoids undesired electric fields that are too strong occurring.

As has already been mentioned, an especially advantageous embodiment of the method makes provision for the optimization to comprise an arrangement of electronic elements outside the irradiation area. This thus means that it is thoroughly conceivable in the course of the optimization method that the electronic elements which were previously arranged in the irradiation area are now removed from the irradiation area and are provided outside the irradiation area, so that the attenuation in the irradiation area also falls overall.

As part of an embodiment of the inventive method, it is not absolutely necessary to take into consideration all electronic elements, but an expedient embodiment makes provision for the electronic elements at least fulfilling one relevance condition to be considered. In such cases there can be provision in concrete terms for an exceeding of a threshold value lying above the attenuation coefficient for water, especially 0.2/cm, by the attenuation coefficient of the electronic element and/or an exceeding of a threshold value, especially 8-10%, by the attenuation value of the electronic element and/or a variable exceeding a predetermined proportion, especially 25-40%, of the size of a PET pixel, 4 by 4 mm, to be used as the relevance condition. Through such a restriction of the electronic elements considered, account is thus taken of which components are relevant at all, so that overall a reduction of the calculation time can be achieved. Electronic elements which only attenuate the PE photons extremely weakly can be removed from consideration precisely as can those which only shade a small fraction of a Line of Response, which match the voxel size in their extent, thus can exhibit a cross-section of 4×4 mm. If now only 25-40% or less of this cross-section is occupied at all by an electronic element, this has only little influence on the measurement and can therefore be ignored. In such cases it is pointed out that naturally also combined new relevance conditions, which logically combine these basic relevance conditions, can be created from these relevance conditions in order to be able to assess in an even more differentiated manner the electronic elements that are of importance for the optimization.

In general, it should be noted that a plurality of optimization algorithms is already known which can also be used within the context of embodiments of the present invention in order, for example, to realize a computer program which carries out the optimization method and outputs an optimum arrangement of the electronic elements. Since optimization methods with the variables to be optimized, here the position of the electronic elements, of the target functions (here related to uniform distribution) and boundary conditions are commonly-used material for the person skilled in the art, the methods will not be discussed in greater detail here.

As well as the method, an embodiment of the invention also relates to a local coil with an arrangement of electronic elements determined with an embodiment of the inventive method. A local coil thus created in accordance with an embodiment of the inventive method is thus characterized in that the heavily-attenuating electronic elements are far better distributed in respect of use in PET imaging, especially approximately evenly distributed. By comparison with prior-art local coils, electronic elements are thus displaced, possibly into areas outside the irradiation area.

It should also be pointed out at this juncture that naturally further measures basically known for improving the compatibility of the local coil with PET imaging can be realized, for example the use of materials with the lightest possible attenuation for other components of the local coil and, where possible also for the electronic elements, as well as embodiments as proposed in DE 10 2008 046 974 A1 cited above, the entire contents of which are hereby incorporated herein by reference.

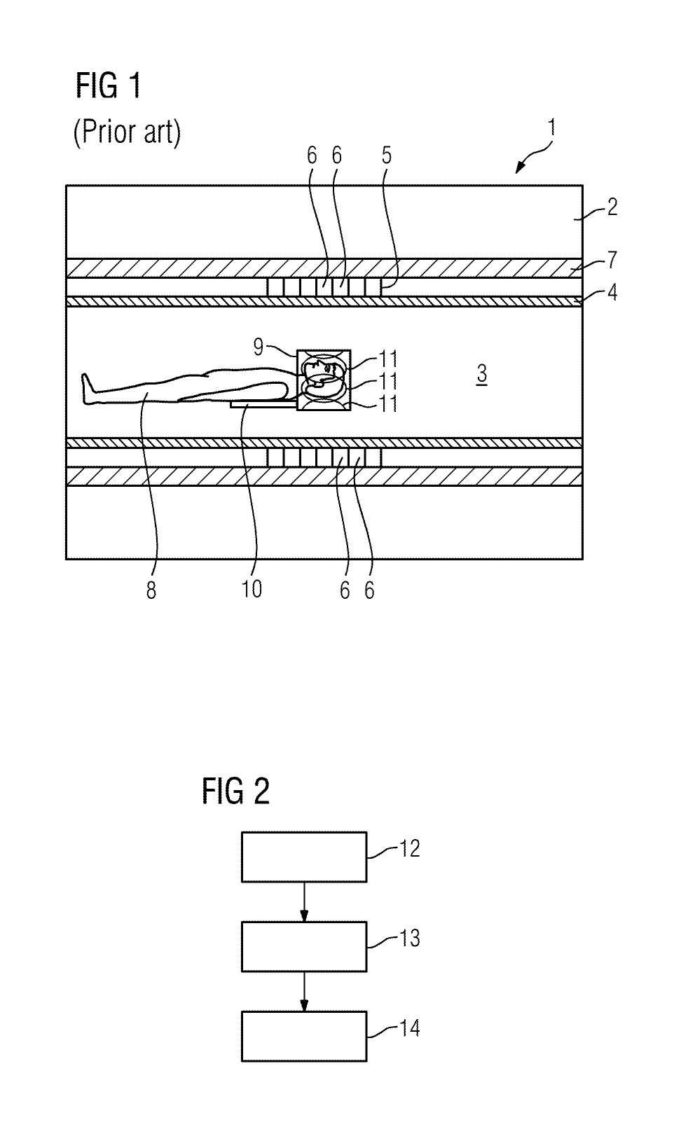

FIG. 1 shows a cross-section through a basically known prior-art combined PET-MR device 1. A patient chamber 3 is defined within a main magnet unit 2, which also contains magnets for creating the basic magnetic field. Surrounding the chamber, from inside to outside, a high-frequency coil arrangement 4, a PET detector arrangement 5 with PET detectors 6 and a gradient coil arrangement 7 are provided. To be able to record higher-quality images of a patient 8 to be brought into the patient chamber 3 only depicted schematically in the figure, local coils 9, 10 are used, which are to be attached close to the patient. The local coil 9 involves a head coil, the local coil 10 involves a back coil which is placed under the patient and is embodied flat. As is shown for example by the example of the local coil 9, such a local coil 9 comprises a number of coil elements 11 formed from corresponding coil conductors, with which magnetic resonance signals can be recorded directly on the patient 8. It can be seen that at least parts of the local coil 9 are located in their imaging position in the radiation path of PET photons possibly arising which can be attenuated there. The area of the local coil 9 which is traversed during the measurement by PET photons able to be received with the PET detectors 6 is the irradiation area. The inventive method now offers an option of embodying this irradiation area in respect of the heavily-attenuating electronic elements so that a low attenuation which is as uniform as possible can be realized and therefore an enhanced image quality can be obtained.

FIG. 2 shows a flowchart of an example embodiment of the inventive method which is executed here fully automatically on a computing device, wherein it is present realized as a computer program. In this flowchart, in a step 12, output data is initially collected about the local coil to be designed, for example the head coil 9, which can also originate from preparatory design steps, for example concerning the course of the coil conductors and thus of the coil elements 11. In any event in step 12 relevant electronic elements and boundary conditions assigned to the elements are defined. In such cases electronic elements are considered to be pulse-shortening capacitors, detuning circuits or PIN diodes of the detuning circuits and solder points, wherein for other example embodiments, if the decoupling is not undertaken by overlapping but by capacitors, decoupling capacitors can also be taken into consideration. Also the inclusion of preamplifiers is conceivable if these lie within the irradiation area. An electronic element is relevant when its total attenuation exceeds 8-10% and the cross-sectional size in the irradiation direction exceeds 30% of a side surface of a PET image element (Voxel) of 4×4 mm. Degrees of freedom for positioning the electronic elements are specified to each electronic element or each class of electronic element. For example pulse-shortening capacitors setting the resonance of the coil elements 11 can only be moved in a specific area while detuning circuits are able to be positioned anywhere, wherein naturally for all electronic elements the course of the associated coil conductors is considered restrictively as a boundary condition. The irradiation area is also defined in step 12.

In a step 13 an optimization method is then carried out with which an as uniform as possible distribution of attenuation centers, i.e. the electronic elements, is to be obtained. For this purpose, as a target function of the optimization method, the course of the attenuation in the longitudinal direction of the essentially cylindrical local coil 9 is evaluated, as is the course of the attenuation in the circumferential direction, wherein the target function is also modified in that electronic elements lying opposite one another at right angles to the longitudinal direction symmetrically along the circumference within a plane are to be avoided where possible, which will be discussed in greater detail below. With a certain weighting a minimization of the electrical fields possibly occurring is also entered into the target function.

In this case the aim in relation to the attenuation curves is to avoid areas of extremely high attenuation, for example an attenuation of 30% and where possible to distribute the attenuation centers. If the irradiation area in the direction considered is divided into subareas, the aim can be to keep the integral for all these subareas of the same size as equal as possible. In this case it should also be pointed out at this juncture that, where the boundary conditions related to the positioning allow this, it is indeed also possible to move electronic elements out of the irradiation area during the optimization so that the overall attenuation there is reduced. To determine the optimum arrangement of the electronic elements, optimization algorithms known in the prior art can be employed.

In a step 14 it is then possible to manufacture a local coil in accordance with the specifications obtained from the optimization method.

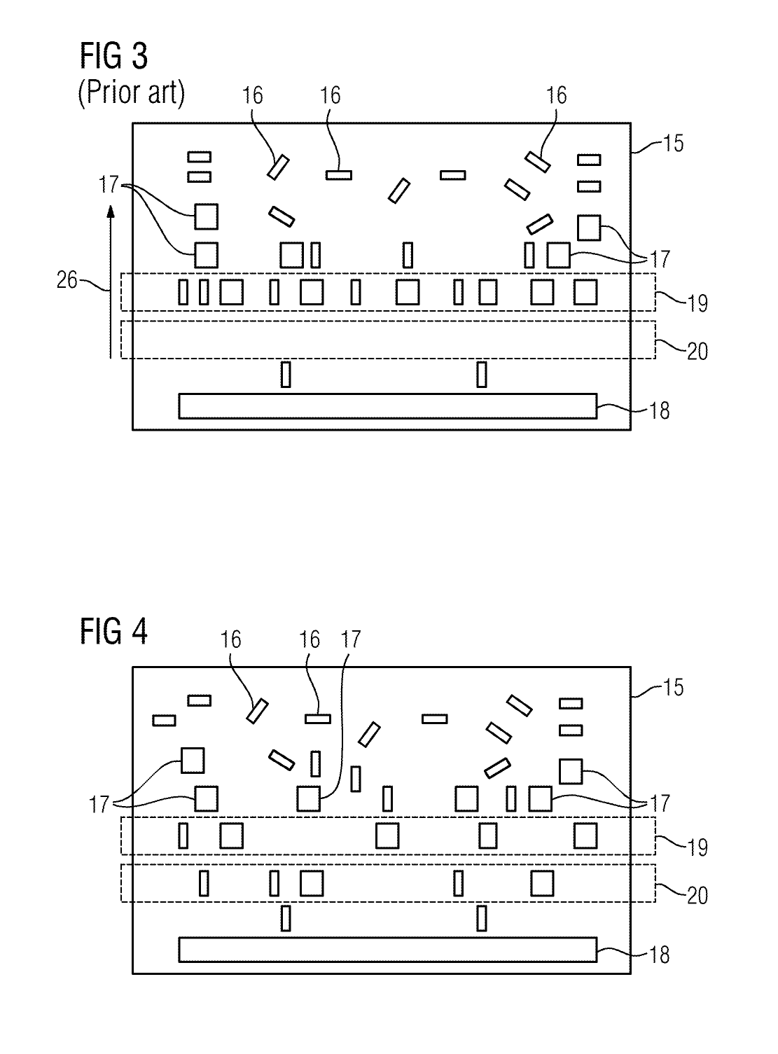

FIG. 3 shows a schematic of the distribution of electronic elements on an essentially cylindrical local coil, of which the surface 15 is viewed here rolled-out for the purposes of presentation. For the sake of simplicity the actual course of the coil conductors is not shown in any greater detail. Shown as longitudinal boxes are pulse-shortening capacitors 16 and as larger blocks detuning circuits 17. The more extended box 18 marks preamplifiers already lying outside the irradiation area.

What is striking about the distribution in FIG. 3 is that an extremely large number of electronic elements is present in one subarea 19, while no electronic elements are present in a subarea 20. But this means that in the longitudinal direction 26 an extremely strongly fluctuating attenuation curve is provided, since no attenuation occurs in subarea 20 but in subarea 19 there is strong attenuation.

If an embodiment of the inventive method is used on this basis an arrangement of the electronic elements as is shown in FIG. 4 is obtained. In this figure the degrees of freedom of positioning for the different electronic elements 16, 17 have been used in order to create a more even distribution, so that especially electronic elements from area 19 have also been displaced into area 20 in order to achieve a balance here. Overall with an embodiment of an inventive local coil of which the surface or envelope surface 15 is shown in FIG. 4, a uniform distribution of the attenuation is present wherein electronic elements have also been moved out of the actual irradiation area.

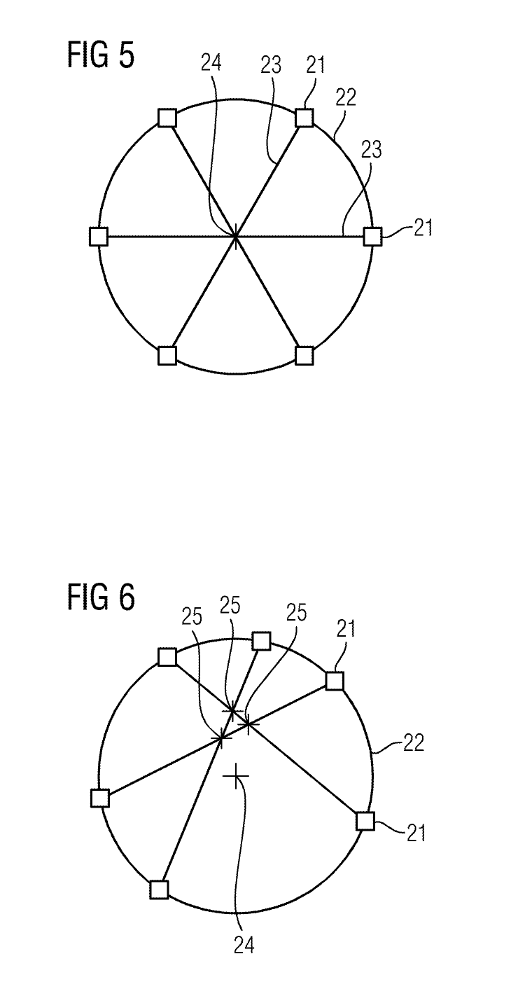

It has also been insured that if a section through the plane in the longitudinal direction is considered, the arrangement in the circumferential direction is such that as few electronic elements as possible lie symmetrically opposite one another. Such an undesired situation is explained in greater detail by FIG. 5. It can be seen in this figure that six electronic elements 21 are arranged in the circumferential direction 22 such that two electronic elements 21 always lie opposite one another. If the connecting lines 23 are considered it can be established that these all meet in the central point 24. For PET events taking place there, a strong attenuation is thus present in especially many directions, which is undesired and is to be avoided.

By comparison FIG. 6 shows an arrangement of the electronic elements 21, as can be produced with an embodiment of the inventive method, in which the symmetrically-opposite electronic elements 21 are to be avoided. It can be seen that in this figure different spatially-separated intersection points 25 are produced.

Although the invention has been illustrated and described in greater detail by the example embodiment, the invention is not restricted by the disclosed examples and other variations can be derived therefrom by the person skilled in the art without departing from the scope of protection of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. Method for designing a local coil to be used in a combined PET magnetic resonance device for magnetic resonance imaging in relation to an arrangement of radiation-attenuating electronic elements in an irradiation area for PET photons, the method comprising:
optimizing, taking into consideration at least one boundary condition specifying a degree of freedom of positioning of the electronic elements, positions of the electronic elements with respect to a uniform distribution of attenuation centers.

2. The method of claim 1, wherein a function evaluating the course of the attenuation in at least one direction along an envelope surface enclosing the local coil is used as an evaluating function.

3. The method of claim 2, wherein, for evaluating the course of the attenuation, at least one band of permissible attenuation values is considered, and wherein areas lying outside the band make the evaluation worse.

4. The method of claim 2, wherein, for an essentially cylindrical local coil, a longitudinal direction and at least one circumferential direction are considered.

5. The method of claim 4, wherein electronic elements lying opposite one another in a circumferential direction are assessed worse in the optimization method as a boundary condition or a modification of the target function.

6. The method of claim 2, wherein the target function includes a component acting to minimize the electric fields occurring.

7. The method of claim 1, wherein the optimization comprises an arrangement of electronic elements outside the irradiation area.

8. The method of claim 1, wherein electronic elements fulfilling at least one relevance condition are taken into consideration.

9. The method of claim 8, wherein at least one of the following is used as the relevance condition:
exceeding of a threshold value above the attenuation coefficient for water by the attenuation coefficient of the electronic elements and
exceeding of a threshold value by at least one of the attenuation value of the electronic element and a size of the electronic element exceeding a predetermined proportion of the size of a PET image element.

10. The method of claim 1, wherein at least one of pulse-shortening capacitors and a least one component of a detuning circuit are considered as electronic elements.

11. The method of claim 10, further comprising:
providing Lambda/2 lines receiving the impedance balancing, a positioning receiving the desired resonance being used as the boundary condition for the positioning of the electronic elements.

12. The method of claim 1, wherein a head coil is considered as the local coil.

13. A local coil comprising:
an arrangement of electronic elements determined with the method of claim 1.

14. The method of claim 3, wherein, for evaluating the course of the attenuation, the at least one band of permissible attenuation values includes an allowed deviation from an average value, and wherein the areas lying outside the band include areas lying above the band.

15. The method of claim 3, wherein, for an essentially cylindrical local coil, a longitudinal direction and at least one circumferential direction are considered.

16. The method of claim 9, wherein the threshold value above the attenuation coefficient for water is 0.2/cm, the exceeding of a threshold value by the attenuation value of the electronic element is 8-10%, a size of the electronic element exceeding a predetermined proportion is 25-40%, and the size of a PET image element is 4 by 4 mm.

17. The method of claim 10, wherein the at least one of pulse-shortening capacitors and a least one component of a detuning circuit, include at least one of a PIN diode, decoupling capacitors, preamplifiers and solder points.
